(19) United States
(12) Patent Application Publication
(10) Pub. No.: US 2008/0051943 A1
(43) Pub. Date: Feb. 28, 2008

(54) Apparatus for calculating detection error of fresh air quantity detection device

(75) Inventor: Kazuhiro Higuchi, Ichinomiya-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/889,194

(22) Filed: Aug. 9, 2007

(30) Foreign Application Priority Data
Aug. 9, 2006 (JP) 2006-216536

(51) Int. Cl. G05D 9/00; G01F 1/00

(52) U.S. Cl. 700/281; 73/861

(57) ABSTRACT

The apparatus for calculating a detection error of a fresh air quantity detection device operating to detect a volume of fresh air taken into an engine intake system of an engine includes a first function of setting the engine in a fuel-cut state, a second function of obtaining a detection value of the fresh air quantity detection device when the engine is set in the fuel-cut state by the first function, and a third function of executing an error detection calculation for detecting a detection error of the fresh air quantity detection device on the basis of a difference between the detection value obtained by the second function and a reference value.

### CROSS-REFERENCE TO RELATED APPLICATION

This application is related to Japanese Patent Application No. 2006-216536 filed on Aug. 9, 2006, the contents of which are hereby incorporated by reference.

### BACKGROUND OF THE INVENTION

1. Field of the Invention

The present invention relates to an apparatus for calculating detection error of a fresh air quantity detection apparatus typified by an airflow meter detecting every moment a volume per unit time of fresh air taken into an engine intake system.

2. Description of Related Art

A detection error may occur in an output of a sensor such as an airflow meter used in an engine control system, due to cumulative performance degradation of the sensor after long use thereof, or temporal performance degradation of the sensor caused, for example, by adhesion of foreign substance (PM, for example) thereto. Such detection error becomes a cause of degraded controllability of the engine control system, especially, in a vehicle on which a diesel engine is mounted, a fresh air quantity detected by an airflow meter may be used as a parameter of an engine management system operating to improve emission. The detection error described above has been one of causes which prevents improving emission.

To cope with this, there are proposed such apparatuses that calculate detection error in a sensor in order to correct a sensor output of the sensor or make judgment as to performance degradation of the sensor. Such apparatuses include the one which calculates detection error of an airflow meter on the basis of a fuel injection volume command value and an output of an A/F sensor (air-fuel ratio sensor). This apparatus is configured to assume the fuel injection volume command value to be an actual fuel injection volume, detect every moment a fresh air quantity on the basis of the fuel injection volume command value and the air-fuel ratio outputted from the A/F sensor, and determine detection error of the air flowmeter by the comparison between this detected fresh air quantity and a detection value of the airflow meter and

Another one of such apparatuses, which is disclosed in Japanese Patent Application Laid-open No. 10-122028, is configured to obtain a basic value (a basic intake air volume) depending on an engine speed by referring to a predetermined map and a detection value of an airflow meter when the engines speed is roughly below 1500 rpm, and to determine a difference between the basic value and the detection value of the airflow meter as detection error of the airflow meter.

As above, there are known various apparatuses for detecting detection error of an airflow meter. However, they all have drawbacks to be solved.

For example, the former conventional apparatus cannot calculate the detection error of the airflow meter with a sufficiently high accuracy, because there is a difference between the fuel injection volume command value and the actual fuel injection volume that varies for each injection.

The latter conventional apparatus has a problem in that its detection range is limited to a low engine speed range (below 1500 rpm) where the fresh air quantity is small, and accordingly the error detection cannot be performed over a sufficiently wide range of the engine speed. Accordingly, with this apparatus, although the detection error of the airflow meter can be sufficiently compensated when the fresh air quantity is small, it can be compensated only insufficiently when the fresh air quantity is large.

### SUMMARY OF THE INVENTION

The present invention provides an apparatus for calculating a detection error of a fresh air quantity detection device operating to detect a volume of fresh air taken into an engine intake system of an engine, comprising:

a first function of setting the engine in a fuel-cut state;

a second function of obtaining a detection value of the fresh air quantity detection device when the engine is set in the fuel-cut state by the first function; and

a third function of executing an error detection calculation for detecting a detection error of the fresh air quantity detection device on the basis of a difference between the detection value obtained by the second function and a reference value.

According to the present invention, it is possible to provide an apparatus that can calculate a detection error of an airflow meter as a fresh air quantity detection device with a high degree of accuracy over a wide range from a state of low fresh air quantity to a state of high fresh air quantity.

The apparatus of the present invention may further comprise a fourth function of making correction to the detection value obtained by the second function to compensate for the detection error calculated by the third function.

The apparatus of the present invention may further comprise a fifth function of detecting a degree of degradation of the fresh air quantity detection device on the basis of the detection error calculated by the third function.

The apparatus of the present invention may further comprise a sixth function of determining the reference value on the basis of a detection value of the fresh air quantity detection device.

The second function may be configured to obtain the detection value when an engine speed of the engine set in the fuel-cut sate by the first function becomes a predetermined reference engine speed associated with the reference value.

The apparatus of the present invention may further comprise a seventh function of variably controlling the volume of fresh air taken into the engine intake system, the second function being configured to cause the seventh function to forcibly adjust the volume of fresh air taken into the engine intake system to a predetermined reference volume of fresh air associated with the reference value before obtaining the detection value of the fresh air quantity detection device.

The seventh function may be configured to control an opening degree of a throttle valve provided in the engine intake system to variably control the volume of fresh air taken into the engine intake system.

The seventh function may be configured to control an EGR volume by an EGR device operating to return a part of exhaust gas flowing through an exhaust passage of the engine to an intake air passage of the engine to variably control the volume of fresh air taken into the engine intake system.

Second function may be configured to obtain the detection value for each of a plurality of different reference values in accordance with detecting conditions predetermined for each of the plurality of the different reference values.

The apparatus of the present invention may further comprise an eights function of judging whether or not the engine is set in the fuel-cut state on the basis of an output of an oxygen concentration sensor provided in an exhaust passage of the engine, and a ninth function of permitting the second function to obtain the detection value if the eights function judges that the engine is set in the fuel-cut state.

The apparatus of the present invention may further comprise a tenth function of permitting the third function to execute the error detection calculation when predetermined execution permission conditions are satisfied.

The predetermined execution permission conditions may include that a time period sufficient to permit the third function to execute the error detection calculation has passed from the time when the third function executed the error detection calculation last time, or a predetermined reference timing.

The apparatus of the present invention may further comprise an eleventh function of varying the time period in accordance with a history of the error detection calculation performed by the third function.

The history may be the number of times that the third function has executed the error detection calculation.

The predetermined execution permission conditions may include that the engine is in a warmed-up state.

Other advantages and features of the invention will become apparent from the following description including the drawings and claims.

### BRIEF DESCRIPTION OF THE DRAWINGS

In the accompanying drawings:

FIG. 1 is a diagram showing an overall structure of an engine control system provided with an apparatus for calculating detection error of an airflow meter as a fresh air quantity detection device detecting a volume of fresh air taken into an engine intake system according to an embodiment of the invention;

FIG. 2 is a flowchart showing a procedure for calculating detection error of the airflow meter;

FIG. 3 is a flowchart for explaining update of a learning execution permission flag;

FIG. 4 is a flowchart showing a procedure for calculating initial values;

FIG. 5 is a flowchart showing a procedure for calculating an initial value #1;

FIG. 6 is a graph showing an example of a relationship between a fresh air quantity and an engine speed;

FIG. 7 is a flowchart showing a procedure for calculating learned values;

FIG. 8 is a flowchart showing a procedure for calculating a degradation value #0; and

FIG. 9 is a diagram for explaining how the output of the airflow meter is corrected.

### PREFERRED EMBODIMENTS OF THE INVENTION

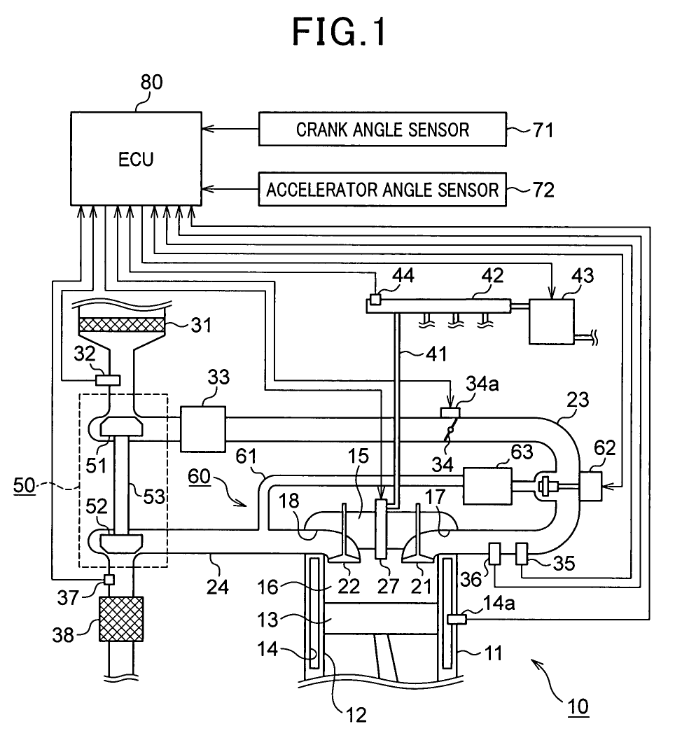

FIG. 1 is a diagram showing an overall structure of an engine control system provided with an apparatus for calculating detection error of an airflow meter detecting a volume of fresh air taken into an engine intake system according to an embodiment of the invention. Although only one cylinder is shown in FIG. 1 to facilitate explanation, this engine control system is intended to control a multi-cylinder (4-cylinder, for example)) engine.

As shown in FIG. 1, this engine control system operating to control a reciprocal diesel engine 10 having a common rail type fuel injection device is constituted by various sensors whose outputs are used for controlling the engine 10, and an ECU (electronic control unit) 80.

The engine 10 includes a cylinder block 11 in which a cylinder 12 is formed (only one cylinder is shown to facilitate explanation). When a piston 13 located in the cylinder 12 reciprocates, a not shown crank shaft as an output shaft rotates.

The cylinder block 11 is provided with a cooling water channel 14, and a cooling water temperature sensor 14a for detecting a temperature of cooling water flowing through the cooling water channel 14 to cool the engine 10. A combustion chamber 16 is formed between a top end surface of the cylinder 13 and a cylinder head 15 fixed on the front end of the cylinder block 15.

The cylinder head 15 is formed with an intake port 17 and an exhaust port 18 opening to the combustion chamber 16. The intake port 17 is opened and closed by an intake valve 21 driven by a not shown cam, and the exhaust port 18 is opened and closed by an exhaust valve 22 driven by a not shown cam. An intake pipe 23 for taking in outside air (fresh air) is connected to the intake port 17. An exhaust pipe 24 for discharging combustion gas is connected to the exhaust port 18.

Fresh air is taken into the intake pipe 23, while foreign matter in the fresh air is being removed by an air cleaner 31 located at the uppermost stream of the intake pipe 23. An airflow meter 32 outputting an electrical signal indicative of a volume of the fresh air (fresh air quantity) is located downstream of the air cleaner 31. The air flowmeter 32 may be of a hot-wire type. An intercooler 33 for cooling the fresh air is located downstream of the airflow meter 32. An electronic control type throttle valve 34 whose opening is adjusted by an actuator such as a DC motor, and a throttle opening sensor for detecting the opening degree or variation of the opening degree of the throttle valve 34 are located downstream of the intercooler 33. An intake air pressure sensor 35 outputting an electrical signal indicative of a pressure of the intake air, and an intake air temperature sensor 36 outputting an electrical signal indicative of a temperature of the intake air are located in the vicinity of the intake port 17.

The exhaust pipe 24 is provided with an A/F sensor 37 which is an oxygen concentration sensor whose output (electrical signal) changes linearly with a change of oxygen concentration in exhaust gas. A DPF (Diesel Particulate Filter) 38 as an exhaust purification device is located downstream of the sensor 37. The DPF filter 38 is a continuously regenerating type PM removing filter for collecting PM (Particulate Matter) fractions in the exhaust gas. It can be continuously used by regularly burning off collected PM by performing post injection after main injection. This DPF 38 carries therein a platinum-based oxidation catalyst, so that SOF (Soluble Organic Fraction) which is one of the PM fractions can be removed together with HC, and CO.

The cylinder 12 is provided with an injector 27 including an electromagnetic driven type fuel injection valve operating to inject-supplies fuel (light oil) into the combustion chamber 16. Although only one injector 27 provided in the cylinder 12 is shown in FIG. 1, each cylinder of the engine 10 is provided with the same injector. Each injector of the engine 10 is connected to a common rail 42 as an accumulator pipe through a high pressure fuel pipe 41. The common rail 42 is supplied with fuel from a fuel pump 43 so that high pressure fuel having an injection pressure is accumulated therein. The common rail 42 is provided with a fuel pressure sensor 44 for detecting the pressure of fuel in the common rail 42 (actual common rail pressure), so that the initial pressure of fuel injected from each injector can be monitored.

Each cylinder of the engine 10 is inject-supplied with fuel by a necessary volume from each injector as demanded. In more detail, when the engine 10 is running, the intake valve 21 is opened to introduce the intake air from the intake pipe 23 to the combustion chamber 16 of the cylinder 12. The intake air introduced is mixed with fuel injected by the injector 27, and compressed as mixed gas by the piston 13 in the cylinder 12 to self ignite and burn. And then the exhaust valve 22 is opened to discharge the resultant exhaust gas into the exhaust pipe 24. According to such a common rail system, since the ECU 80 operating to control the engine performs the control of the fuel system, it is possible to supply fuel by any required volume and pressure at any required time without being substantially affected by the running state of the engine (rotational speed, or load, for example).

This system further includes a turbocharger 50 located between the intake pipe 23 and the exhaust pipe 50. The turbocharger 50 includes an intake air compressor 51 located midway of the intake pipe 23 (between the airflow meter 32 and the intercooler 33), and an exhaust turbine 52 located midway of the exhaust pipe 24 (upstream of the A/F sensor 37). The intake air compressor 51 and the exhaust turbine 52 are coupled to each other through a shaft 53. The exhaust turbine 52 rotates by the exhaust gas flowing through the exhaust pipe 24, and this rotation is transmitted to the intake air compressor 51 through the shaft 53, as a result of which the intake air is compressed to thereby supercharge the engine 10. By this supercharging, charging efficiency of intake air into each cylinder is increased. Since the supercharged intake air is cooled by the intercooler 33, the charging efficiency is further increased.

An EGR (Exhaust Gas Recirculation) device 60 is also located between the intake pipe 23 and the exhaust pipe 24 in order to return a part of the exhaust gas to the air intake system side. The EGR device 60 is mainly constituted by an EGR pipe 61 connecting the intake pipe 23 and the exhaust pipe 24 to each other in the vicinity of the intake and exhaust ports, an EGR valve 62 located downstream of the throttle valve 34 of the intake pipe 23 to enable adjusting the passage area of the EGR pipe 61, and accordingly an EGR volume (volume of recirculation) through control of the opening thereof, and an EGR cooler 63 for cooling the EGR gas flowing through the EGR pipe 61. The EGR device 60 having the above described structure serves to lower the combustion temperature to thereby suppress generation of NOx by returning a part of the exhaust gas to the air intake system through the EGR pipe 61.

A vehicle (not shown) provided with this engine control system has various sensors mounted thereon other than the sensors described above. For example, the vehicle is provided with a crank angle sensor 71 outputting a crank angle signal for each predetermined crank angle (30° CA period, for example) to enable detection of a crank position (rotation angle position) as well as the engine speed, and an accelerator angle sensor 72 outputting an electrical signal indicative of a depression volume of an accelerator of the vehicle.

The ECU 80, which is a microcomputer-based electronic control unit, drives various actuators including the injectors 27 as demanded on the basis of the running state of the engine 10, and output signals of various sensors detecting requirements of a vehicle driver. A microcomputer mounted in the ECU 80 is mainly constituted by a CPU performing various operations, a RAM as a main memory for temporarily storing data or intermediate operation results, a ROM as a program memory, and an EEPROM as a storage of data. The ROM stores therein various programs including a program for calculation of detection error of the airflow meter 32, and various control maps for engine control. The EEPROM stores therein various control data including design data of the engine 10.

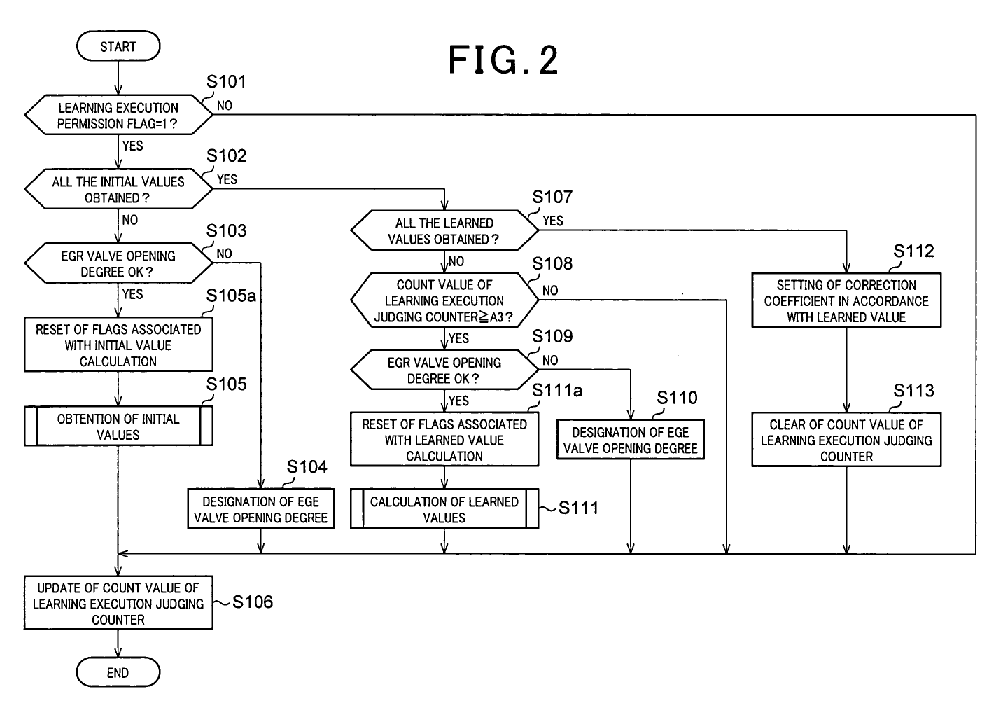

Next, the operation of this system is explained with reference to FIGS. 2 to 9.

FIG. 2 is a flowchart showing a procedure for calculating the detection error of the airflow meter 32. This procedure is performed by the ECU 80 on the basis of the program stored in the ROM.

In this system, when the depression volume (accelerator opening) of the accelerator becomes small (for example, when the accelerator is fully closed) while the vehicle is in a sufficiently accelerated state, fuel supply to the engine 10 is cut. In consequence, fuel injection to the engine 10, and accordingly fuel combustion are stopped, as a result of which the turbocharger 50 driven by exhaust gas is stopped. The procedure shown in FIG. 2 is performed repeatedly for each predetermined crank angle or at regular time intervals while the engine 10 is in such a fuel-cut state. The values of various parameters used in the procedure shown in FIG. 2 are stored in the RAM or EEPROM mounted in the ECU 80 and changed as needed.

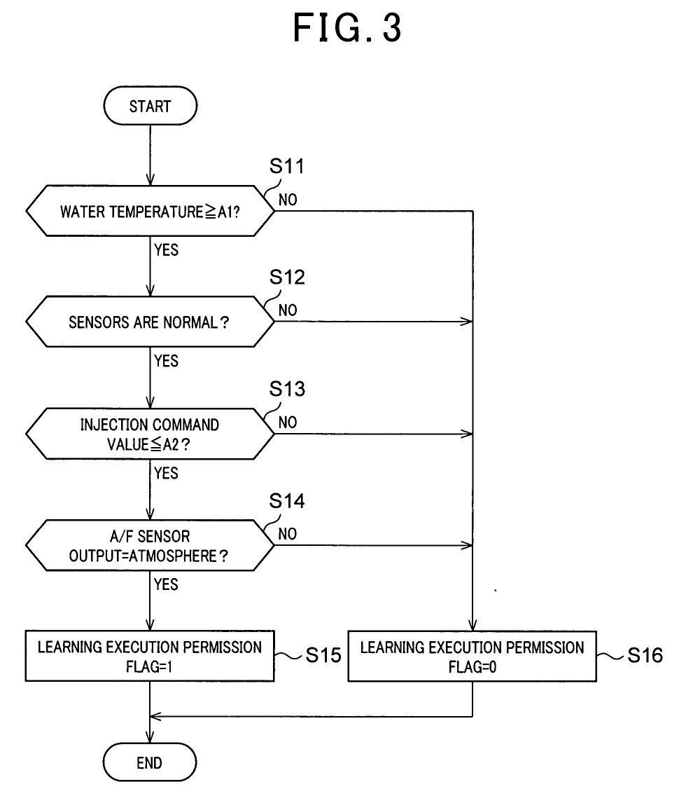

This procedure begins by judging at step S101 whether or not a learning execution permission flag is set at “1”. The learning execution permission flag is a flag indicative of whether or not predetermined execution permission conditions including that the engine 10 is in the fuel-cut state have been satisfied. Next, a detailed explanation about this learning execution permission flag is given with reference to the flowchart of FIG. 3. In this embodiment, the procedure shown in FIG. 3 is also performed repeatedly for each predetermined crank angle or at regular time intervals.

As shown in FIG. 3, in this procedure, it is checked whether or not the following four conditions are satisfied by performing steps S11 to S14.

The engine 10 is in a warmed-up state, that is, the cooling water temperature of each cylinder is equal to or above a predetermined threshold value A1 (step S11).

All the sensors associated with the calculation of the detection error are normal (step S12).

The injection volume command value of each cylinder is equal to or below a predetermined threshold value A2 (step S13).

The output value of the A/F sensor 37 indicates atmosphere. To be exact, the output value of the A/F sensor 37 is not less than a predetermined value roughly equivalent to the atmospheric value. If it is determined that all of these four conditions are satisfied at the same time, since it means that it is necessary to perform the error detection calculation, the procedure proceeds to step S15 where the learning execution permission flag is set to “1”, and then it ends. On the other hand, if it is determined that at least one of the four conditions is not satisfied, since it means that it is not necessary to perform the error detection calculation, the procedure proceeds to step S16 where the learning permission flag is set to “0”, and then it ends.

The procedure shown in FIG. 2 is repeatedly performed to execute only step S101 and step S106 in order to update a learning execution judging counter until the learning execution permission flag is set to “1” by the procedure shown in FIG. 3. The count value of the learning execution judging counter updated at step S106 indicates a travel distance, or the distance the vehicle has traveled since it was reset last time. In this embodiment, the procedure shown in FIG. 2 obtains a value of the travel distance calculated on program performed by another vehicle control, and updates the learning execution judging counter with this value after making a necessary change to this value.

If it is judged at step S101 that the learning permission execution flag has been set to “1” by the procedure shown in FIG. 3, the procedure proceeds to step S102 where a detection value of the airflow meter 32 in a period during which the airflow meter 32 shows a good performance is obtained as an initial value used as a reference in calculating the detection error of the air flow meter 32. This initial value is obtained for each of predetermined detection error calculation points. At this step S102, it is also judged whether or not all the initial values for these detection error calculation points have been obtained. If the judgment at step S102 is affirmative, the procedure proceeds to step S103.

At step S103, it is judged whether or not the current EGR valve opening degree (current opening degree of the EGR valve 62) is within a predetermined range around a target opening degree predetermined as a condition for obtention of the initial values. If the result of the judgment at step S103 is negative, the procedure proceeds to step S104 where the EGR valve 62 is driven so that the opening degree thereof becomes the target opening degree. The operation of step S104 is executed repeatedly until the opening degree of the EGR valve 62 becomes equal to the target opening degree. In this embodiment, the error detection calculation points are set at three points different in engine speed (a first reference engine speed KNE1 about equal to 2,500 rpm, a second reference engine speed KNE2 about equal to 2,000 rpm, and a third reference engine speed KNE3 about equal to 1,500 rpm) for each of two different opening degrees (0% and 50%, for example) of the EGR valve 62. And the initial value, a degradation value, and a learned value (a detection error depending on a difference between the degradation value and the initial value as reference values) are obtained in succession for each of these six points.

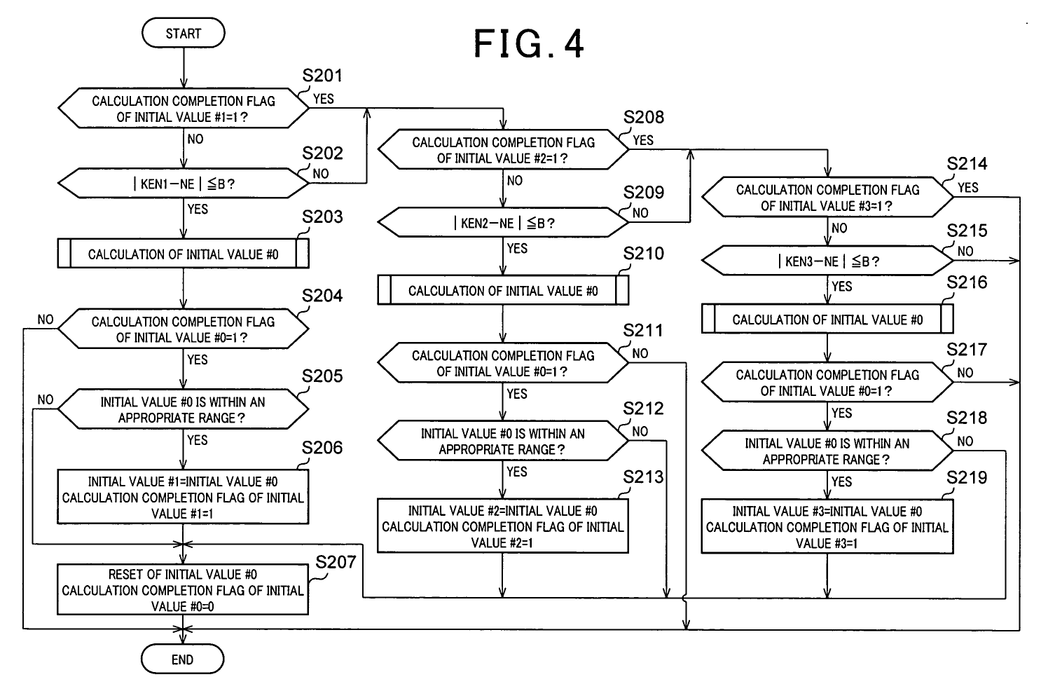

If it is judged at step S103 that the opening degree of the EGR valve 62 agrees with the target opening degree, flags associated with the initial value calculation are reset to 0 at step S105a. After that, the procedure proceeds to step S105. At step S105, the initial value is calculated for each detection error calculation point in accordance with the procedure shown in FIG. 4. Here, the initial values #1 to #3 are calculated for each of the three engine speeds (the reference speeds KNE1, KNE2, and KNE3) when the EGR valve opening degree is 0%. The procedure for the initial value calculation is explained below with reference to the flowchart of FIG. 4.

As shown in FIG. 4, this procedure begins by judging at step S201 whether or not a calculation completion flag of the initial value #1 is set at “1”. When the calculation of initial value #1 has not been completed, since the calculation completion flag of initial value #1 is in a reset state (=0), steps S202 to S206 are executed to calculate the initial value #1 in a way described below.

At step S202, it is judged whether or not the current engine speed NE is at substantially the same level as the reference speed KNE1. More specifically, it is judged whether or not the absolute value of difference between KNE1 and NE is equal to or smaller than a predetermined threshold value B (25 rpm, for example). The judgment at step S202 is performed repeatedly until the current speed NE becomes substantially the same level as one of the reference speeds KNE1 to KNE3. When the current speed NE has substantially reached one of the reference speeds KNE1 to KNE3, calculation of one of the initial values #1 to #3 corresponding to the reached reference speed starts. Actually, since the engine speed gradually decreases during the fuel-cut period, the engine speed NE first reaches the level of the reference speed KNE1 before it reaches the reference speeds KNE2 and KNE3. Accordingly, here, explanation is made assuming that the engine speed NE reaches the reference speed KNE1, KNE2, KNE3 in this order.

If it is judged that the absolute value of KNE1-NE is smaller than the threshold value B at step S202, since it means that the engine speed NE is at the same level as the reference speed KNE1, the initial value #0 is calculated at step S203. The operation of step S203 is executed repeatedly until it is judged at step S204 that the calculation completion flag of the initial value #1 is set at “1”. The following is a detailed explanation of this procedure for calculating the initial value #0.

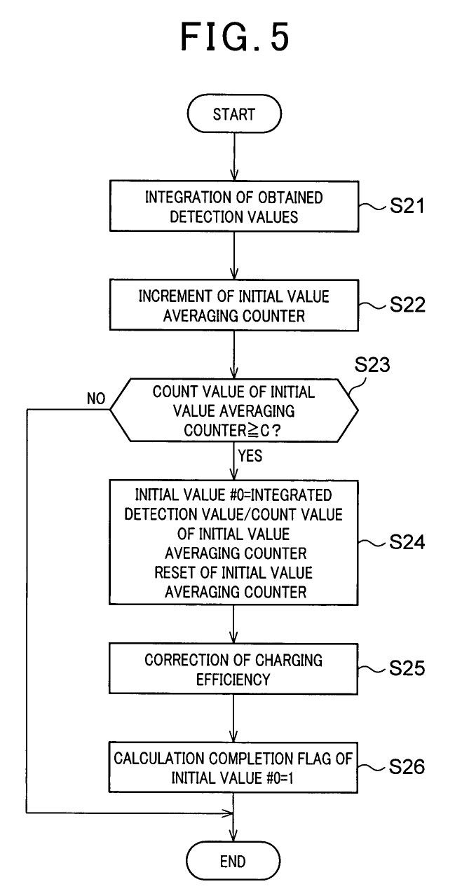

As shown in FIG. 5, this procedure begins by obtaining a detection value of the airflow meter 32 and integrating this obtained detection value at step S21. Subsequently, the count value of an initial value averaging counter is incremented from an initial value of 0 at step S22. Next, at step S23, it is judged whether or not the count value of the initial value averaging counter has reached a predetermined number C (3, for example). The operation of step S21 is performed repeatedly until the judgment at step S23 becomes affirmative. After that, at step S24, the initial value #0 is calculated as a mean value of the detection values of the airflow meter 32 by dividing the C times integrated detection values by the count value C of the initial value averaging counter, and then the initial value averaging counter is reset to 0.

Next, at step S25, correction (charging efficiency correction) is made to the calculated initial value #0 on the basis of the intake air pressure and the intake air temperature respectively detected by the intake air pressure sensor 35 and the intake air temperature sensor 36. In this embodiment, for the intake air pressure that has a large effect on the charging efficiency, a correction coefficient is determined on the basis of a correction coefficient map which uses the engine speed and intake air pressure as parameters. On the other hand, for the intake air temperature that has a relatively small effect on the charging efficiency, a coefficient is determined on the basis of a simple table or an expression defining a relationship between the intake air temperature and the correction coefficient. And the calculated initial value #0 is corrected on the basis of these determined coefficients. The corrected initial value #0 is stored in the EEPROM or the like.

Thereafter, the calculation completion flag of the initial value #0 is set to “1” at step S26, to complete this procedure. The procedure shown in FIG. 4 proceeds from step S204 to step S205 when the calculation completion flag of the initial value #0 is set to “1” by the procedure shown in FIG. 5.

At step S205, it is judged whether or not the calculated initial value #0 is within an appropriate range. This appropriate range, which is for detecting unexpected abnormality, can be determined through experiment taking into account of individual difference. If the result of the judgment at step S205 is negative, it means that the value of the initial value #0 is abnormal even allowing for individual difference.

If the result of the judgment at step S205 is affirmative, the value of the initial value #0 is substituted into the initial value #1, and the calculation completion flag of the initial value #1 is set to “1”. Subsequently, the initial value #0 and the calculation completion flag of the initial value #0 are reset (reset to “0” for example). On the other hand, if the result of the judgment at step S205 is negative, the initial value #0 and the calculation completion flag of the initial value #0 are reset at step S207 with the calculation completion flag of the initial value #1 being kept at “0”, and then the procedure returns to step S201 to perform the calculation again.

When the initial value #1 is obtained and the calculation completion flag of the initial value #1 is set to “1”, and accordingly the result of the judgment at step 201 becomes affirmative, the procedure proceeds from step S201 to step S208. By executing steps S208 to S213, and steps S214 to S219 which are similar to steps S201 to S206, the initial value #2 and the initial value #3 are obtained. Thus, at step S105 shown in FIG. 2, the initial values #1 to #3 for the reference speeds KNE1 to KNE 3 when the EGR valve opening degree is 0% are obtained by performing the procedure shown in FIG. 4.

Thereafter, the initial values (reference values) for the other three detection error calculation points are obtained. That is, after the opening degree of the EGR valve 62 is adjusted to 50% by the operations of step S103 and step S104, the initial values #1 to #3 are calculated at step S105 in a way similar to the above, and stored in the EEPROM or the like.

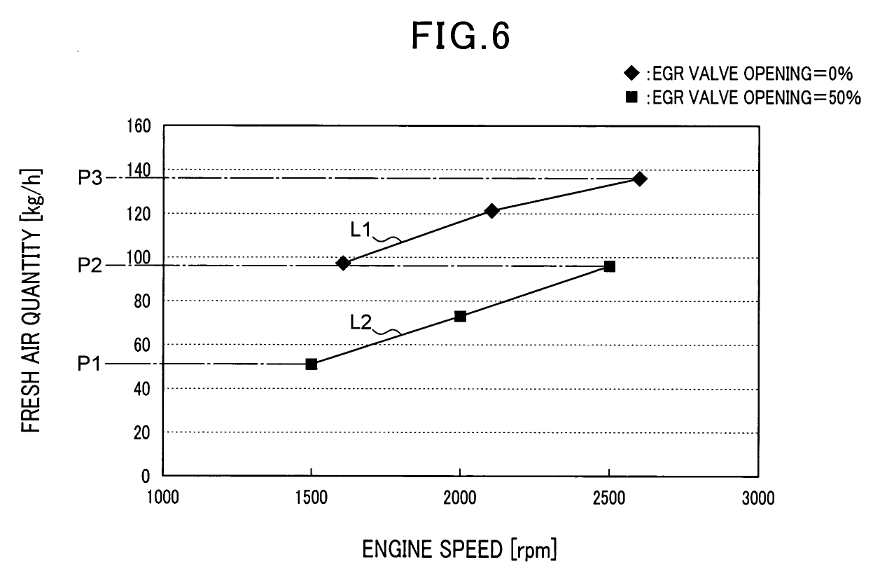

To obtain the initial values for the other three points, since the engine speed has to be above the reference speed KNE1 (about 2,500 rpm), these operations are executed at the time of next fuel-cut, that is, after the learning execution permission flag is once set to “0” and set to “1” again afterward. It should be noted that the reference speeds KNE1 to KNE3 are set to new values on the basis of the relationship between the fresh air quantity and the engine speed, so that the initial values and learned values (correction coefficients) can be obtained over a sufficiently wide range from small fresh air quantity to large fresh air quantity. FIG. 6 is a graph showing an example of the relationship between the fresh air quantity and the engine speed when the intake air temperature is 25° and the piston displacement of the engine is 1,700 cc.

In this graph, the curve L1 and the curve 2 represent the relationship between the fresh air quantity and the engine speed when the EGR valve opening degree is 0%, and 50% respectively. By setting the detection error calculation points (engine speeds) on the curve L1 when EGR valve opening is 0%, and the setting detection error calculation points on the curve L2 when EGR valve opening is 50%, it becomes possible to obtain the initial values and the learned values (correction coefficients) over a wide range from P1 to P3 of the fresh air quantitys.

When all the initial values have been obtained in this way, the result of the judgment at step S102 becomes affirmative, and as a result, the procedure proceeds from step S102 to step S107 where it is judged whether or not all the learned values have been obtained. At subsequent step S108, it is judged whether or not it is a proper time to calculate the learned values. To be more exact, it is judged at step S108 whether or not the count value of the learning execution judging counter, which is equivalent to the traveled distance, is equal to or larger than a threshold value A3 variably set according to the number of executions of the learned value calculation. If it is judged that this count value is equal to or larger than the threshold value A3, since it means that a time sufficient to permit the execution of the learned value calculation has passed from the time when the learning execution judging counter was reset last time, the degradation values and the learned values (for six points corresponding to the initial values) are started to be calculated.

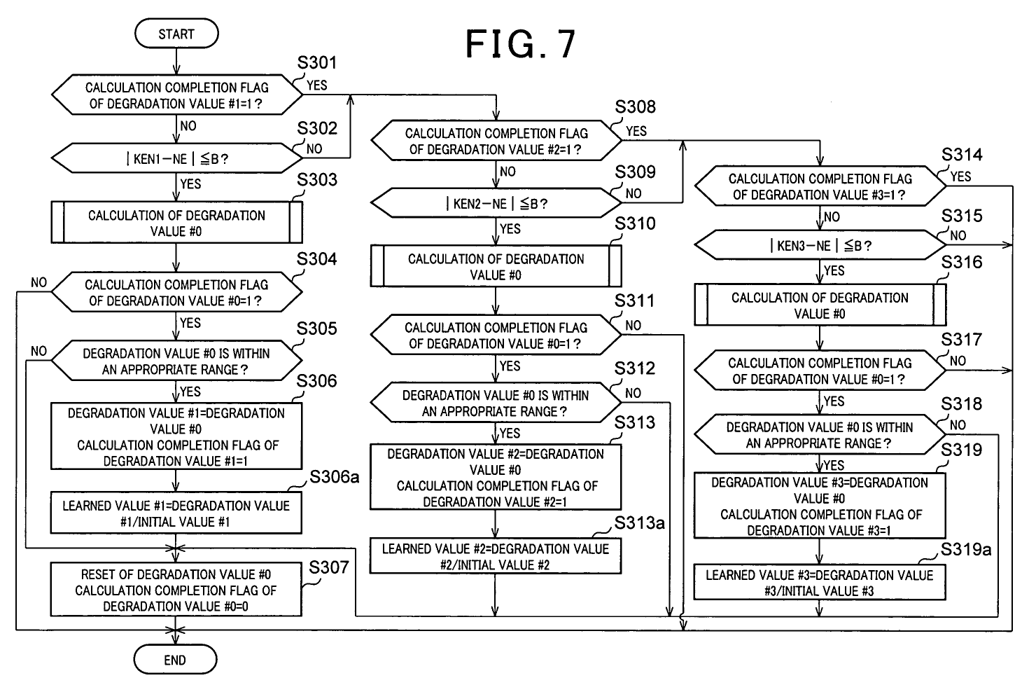

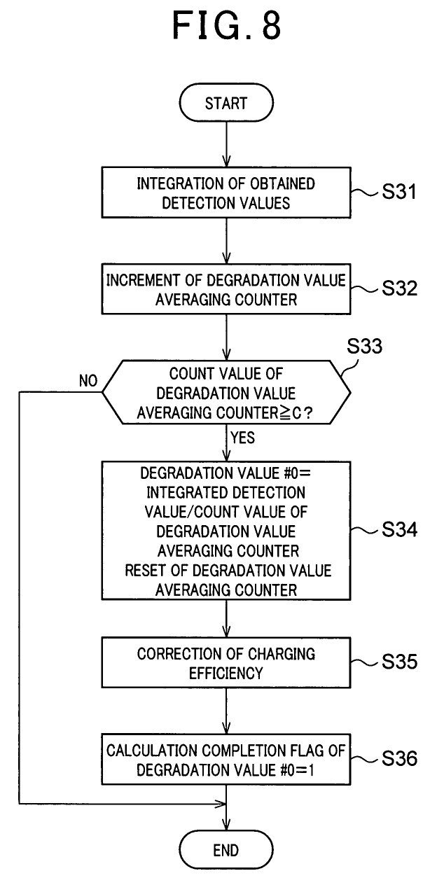

The calculations of the degradation value and the learned values are performed by a procedure similar to the procedure for calculating the initial values as described below. That is, after adjusting the opening degree of the EGR valve 62 to 0% by the operations of steps S109 and S110, flags associated with the learned value calculation (calculation completion flags of the degradation value #1 to #3) are reset to “0”, and then the procedure proceeds to step S111. At step S111, the degradation value and the learned value are calculated by a procedure shown in FIG. 7 for each of the above described six points. In the following, the procedure for calculating the degradation value and the learned value are explained with reference to FIG. 7 and FIG. 8.

As shown in FIG. 7, this procedure executes operations of step S301 to S319 which are similar to step S201 to 219 shown in FIG. 4. At each of steps S303, S310, and S316, a procedure shown in FIG. 8 is performed. In more detail, the degradation values #1 to #3 corresponding to the initial values #1 to #3 are calculated when a sufficient time has passed from the time when the learning execution judging counter was rest by executing steps S31 to S36 shown in FIG. 8 which are similar to steps S21 to S26 shown in FIG. 5, and these calculated values are stored in the EEPROM or the like. In this procedure, steps S306, S313, S319 are respectively followed by steps S306a, S313a, S319a. In these steps, the learned values #1 to #3 as degradation coefficients are calculated by dividing the degradation values #1 to #3 calculated at step S35 in FIG. 8 by the initial values #1 to #3 calculated at step S25 in FIG. 5, respectively, and stored in the EEPROM or the like.

Next, the degradation values, and the learned values are obtained for the other three detection error calculation points as in the case of the initial values. That is, after the opening degree of the EGR valve 62 is adjusted to 50% by the operations of step S109 and step S110 in FIG. 2, the initial values #1 to #3 are calculated at step S111 in a way similar to the above, and stored in the EEPROM or the like. These learned values are values indicative of detection errors of the airflow meter 32. When the learned value is large, it means that the detection error of the airflow meter is large.

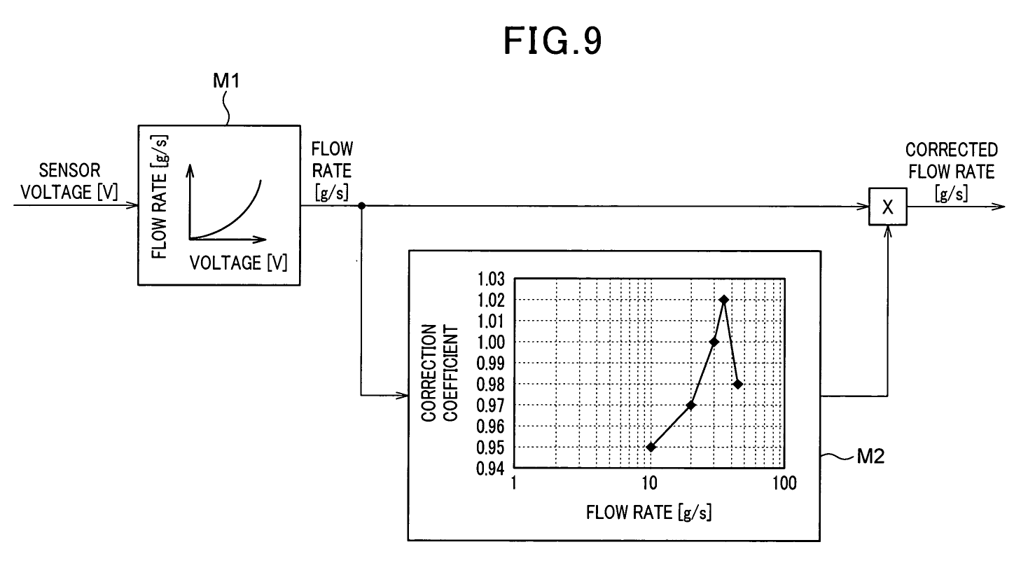

When all the learned values have been obtained, the judgment at step S107 becomes affirmative. In this case, at subsequent step S112, a correction coefficient (=1/learned value) is set for the detection value of the airflow meter 32 on the basis of the learned value for each of these six points For example, the relationship between the fresh air quantity and the correction coefficient is mapped as shown in FIG. 9.

The output (voltage value) of the airflow meter 32 is converted into a flow rate by referring to a predetermined map M1 representing a relation ship between the voltage value and the fresh air quantity (flow rate) as shown in FIG. 9, and the converted flow rate is used for various controls. In this embodiment, a map M2 representing the relationship between the fresh air quantity (flow rate) and the correction coefficient is produced at step S112 on the basis of the learned values for the six points obtained at step SS111. And the flow rate converted by use of the map M1 is corrected on the basis of this map M2. And the corrected flow rate is used for various controls.

As described above, this embodiment is so configured that the detection error of the airflow meter 32 is calculated, and the detection value of this airflow meter is compensated for this detection error. And at step S113 following step S112, the count value of the learning execution judging counter is reset. Afterward, when it is judged that the count value has reached again the threshold value A3 at step S108, the learned value is again calculated, and the correction coefficient (map M2) is updated. The correction coefficient (map M2) is updated repeatedly thereafter. In this embodiment, the threshold value A3 is set smaller as the execution times of the learned value calculation increases.

The above described embodiment of the invention offers the following advantages.

(1) The ECU 80 serving as an apparatus for calculating detection error of the airflow meter 32 operating to detect a volume of fresh air taken into the engine 10 includes a function of setting the engine 10 in a fuel-cut state, a function (step S31 in FIG. 8) of obtaining detection values of the airflow meter 32 when the engine 10 is set in the fuel-cut state, and a function (steps S306a, S313a, S319a in FIG. 7) of calculating detection errors (learned values for six points) of the airflow meter 32 by comparing obtained detection values (detection values for the six points) with corresponding reference values (initial values for the six points). This configurations makes it possible to calculate the detection error of the airflow meter 32 with high accuracy over a wide range from a state of low fresh air quantity to a state of high fresh air quantity.

(2) The ECU 80 further includes a function of averaging a plurality of the detection values of the airflow meter 32 obtained by performing the detection operation multiple times (three times, for example) in order to determine a definitive detection error (learned value). This makes it possible to calculate the detection error of the airflow meter 32 with further higher degree of accuracy.

(3) The ECU 80 further includes a function (step S112 in FIG. 2) of correcting the detection value of the airflow meter 32 to compensate for the detection error calculated at steps S306a, S313a, S319a. This makes it possible to sufficiently correct the detection value of the airflow meter 32 over a wide range from a state of low fresh air quantity to a state of high fresh air quantity. Accordingly, since the fresh air quantity can be measured with a high degree of accuracy over a wide range, it is possible to improve emission through various controls using the measured value of the fresh air quantity

(4) The ECU 80 further includes a function (step S105 in FIG. 2) of obtaining the reference values (initial values for the six points) on the basis of the detection values of the airflow meter 32. This makes it possible to calculate the detection error of the airflow meter 32 without being affected by individual difference.

(5) The ECU 80 further includes a function (steps S302, S309, S315 in FIG. 7) of detecting, when the engine speed decreasing during the fuel-cut period has reached the same levels as one of the reference engine speeds (reference speeds KNE1, KNE2, KNE3) which are predetermined corresponding to the reference values (initial values #1 to #3), a detection value of the airflow meter 32 associated with the reached reference engine speed. This makes it possible to calculate the detection error accurately while meeting use conditions of the EC 80.

(6) The ECU 80 further includes a function (step S109, step S110 in FIG. 2) of variably controlling the volume of fresh air taking into the intake system of the engine 10, and is configured to obtain the detection values of the airflow meters 32 after forcibly adjusting the fresh air quantity to the same level as one of the reference volumes (EGR valve opening degree=0%, or 50%) predetermined for each of the reference values (the initial values for the six points). This makes it possible to calculate the detection error over a wide range allowing for engine speed variation.

(7) This embodiment is configured to variably control the fresh air quantity by controlling the EGR volume (recycling volume) through the EGR device operating to return a part of the exhaust gas flowing through the exhaust passage to the intake air passage. This makes it possible to adjust the fresh air quantity accurately while keeping the drivability in good condition.

(8) The ECU 80 further includes a function (step S35 in FIG. 8) of correcting the detection value of the airflow meter 32 on the basis of the intake air pressure and the intake air temperature being detected every moment, and obtaining the detection value after being corrected. This makes it possible to remove variation of the calculated fresh air quantity due to variation of detecting condition.

(9) This embodiment is configured to obtain the detection values (degradation values for the six points) in accordance with detecting conditions (engine speed, and EGR valve opening degree) predetermined for each of the reference values (initial values for the six points) by executing steps S109, S110 in FIG. 2, or steps S302, S309, S316 in FIG. 7. This makes it possible to calculate the detection error accurately over a wide range of the fresh air quantity.

(10) In addition, since the fresh air quantity decreases with decrease of the engine speed, the detection value (degradation value) of the airflow meter 32 can be obtained in the order of from a high engine speed region to a low engine speed region.

(11) The ECU 80 further includes a function (steps S11 to S16 in FIG. 3) of judging whether or not the engine 10 has been set in the fuel-cut state on the basis of the output of the oxygen concentration sensor 37 located in the exhaust passage, and a function (step S101 in FIG. 2) of permitting obtention of the detected value (degradation value) of the airflow meter 32 when the engine 10 is judged not to be set in the fuel-cut state by this function. This configuration makes it possible to prevent erroneously obtaining the detection value of the airflow meter 32. Since most vehicles are provided with the oxygen concentration sensor at their exhaust passage, such a configuration can be attained without difficulty.

(12) The ECU 80 further includes a function (step S101 in FIG. 2) of permitting execution of the learned value calculation only if predetermined execution permitting conditions are satisfied. This makes it possible to lessen the load of the ECU 80.

(13) The execution permitting conditions include that a time sufficient to permit the execution of the learned value calculation has passed from the time when the learned value calculation was performed last time, or since a predetermined reference timing. This makes it possible to prevent execution times of the detection error calculations from unnecessarily increasing while enabling detection of any significant variation of the detection error.

(14) Since the judgment as to whether a time sufficient to permit execution of the learned value calculation has passed is made on the basis of a traveled distance of the vehicle which is used also in other controls, the judgment can be made easily and with high reliability.

(15) The ECU 80 further includes a function of varying the above described time as criteria for judging whether or not the learned value calculation should be performed in accordance with the history of the execution (execution times of the learned value calculation). This makes it possible to perform the learned value calculation in more appropriate way.

(16) The execution permitting conditions of the learned value calculation include that the engine 10 is in a warmed-up state (step S11 in FIG. 3). This makes it possible to remove variation of the calculated fresh air quantity due to variation of detecting conditions.

It is a matter of course that various modifications can be made to the above described embodiment.

To variably control the fresh air quantity at the time of obtaining the detection value of the airflow meter 32, the opening degree of the throttle valve 34 provided in the intake system of the engine 10 may be controlled instead of or together with the EGR valve opening. This configuration also enables accurately controlling the fresh air quantity in the fuel-cut state.

Although the above described embodiment is configured to make correction to the detection value (degradation value) of the airflow meter 32 on the basis of the intake air pressure and the intake air temperature in order to correct the charging efficiency, it is desirable to correct the detection value of the airflow meter 32 taking an intake air humidity into account, if there is provide means for detecting humidity of the intake air.

The above described embodiment is configured to make a judgment as to whether or not a time sufficient to permit execution of the learned value calculation has passed on the basis of the threshold value A3 incremented depending on the traveled distance of the vehicle (step S108 in FIG. 2). Instead of this, the judgment may be made directly on the basis of the actual elapsed time if the threshold value A3 is incremented with time.

The above described embodiment is so configured that the threshold value A3 is varied in accordance with the number of times that the learned value calculation has performed. However, it may be so configured that the threshold value A3 is varied in accordance with the history of the learned value calculation including an elapsed time from the time when the learned value calculation was first performed. This configuration can also provide the advantage (15).

The threshold value A3 does not have to be varied, but may be fixed in order to simplify the system in structure.

The computation contents of the correction is not limited to multiplication by the correction coefficient (FIG. 9). The correction may be made more accurately by performing a combination of the four fundamental operations of arithmetic, differentiation, or integration.

Although the above described embodiment is configured to obtain, at step S105 in FIG. 2, the reference values (initial values for the six points), the reference values may be fixed values.

Although the above described embodiment is configured to average a plurality of the detection values (degradation values) of the airflow meter 32 to determine a definitive detection error (learned value), it may be configured to average a plurality of the detection errors instead of the detection values. Using the average value is not absolutely necessary. If sufficiently high accuracy can be assured, it is not necessary to average the plurality of the detection values.

The number of the correction coefficients, which is six in the above described embodiment, may be any number. Increasing the number of the correction coefficients is effective in improving accuracy of the correction, on the other hand, reducing the number of the correction coefficients is effective in reducing the load of the ECU 80.

The ECU 80 may further include a function of detecting a degree of degradation of the airflow meter 32 on the basis of the detection errors (learned values) calculated at steps S306a, 313a, 319a. For example, the embodiment may be so configured to judge whether or not a learned value (degradation coefficient) is larger than a predetermined threshold, perform the above described correction if it is judged that the degradation coefficient is smaller than the threshold value, and, if it is judged that the degradation coefficient is larger than the threshold value, write diagcodes or inform the vehicle driver of this. This configuration makes it possible to detect malfunction of the airflow meter 32 at an early stage, and also to prevent the actuators controlled on the basis of the output of the airflow meter 32 from malfunctioning.

The point is that if the apparatus (ECU 80) for calculating the detection error of the airflow meter 32 as a fresh air quantity detection device includes the function of setting the engine 10 in the fuel-cut state, the function of obtaining the detection value of the airflow meter 32 when the engine 10 is set in the fuel-cut state, and the function of calculating the detection error of the airflow meter 32 by comparing the obtained detection value and a corresponding reference value, an advantage the same as or similar to the advantage (1) can be obtained. Accordingly, step S101 in FIG. 2 may be excluded to perform the calculation of the detection error (learned value) each time the engine 10 is set in the fuel-cut state.

Although the above described various functions are implemented by executing various programs, they may be implemented in hardware.

Although the above described embodiment shows a case where the present invention is applied to a diesel engine having a common rail system, the present invention is applicable to a spark-ignition type gasoline engine (especially, direct injection type engine).

The above explained preferred embodiments are exemplary of the invention of the present application which is described solely by the claims appended below. It should be understood that modifications of the preferred embodiments may be made as would occur to one of skill in the art.

What is claimed is:

1. An apparatus for calculating a detection error of a fresh air quantity detection device operating to detect a volume of fresh air taken into an engine intake system of an engine, comprising:
a first function of setting said engine in a fuel-cut state;
a second function of obtaining a detection value of said fresh air quantity detection device when said engine is set in said fuel-cut state by said first function; and
a third function of executing an error detection calculation for detecting a detection error of said fresh air quantity detection device on the basis of a difference between said detection value obtained by said second function and a reference value.

2. The apparatus according to claim 1, further comprising a fourth function of making correction to said detection value obtained by said second function to compensate for said detection error calculated by said third function.

3. The apparatus according to claim 1, further comprising a fifth function of detecting a degree of degradation of said fresh air quantity detection device on the basis of said detection error calculated by said third function.

4. The apparatus according to claim 1, further comprising a sixth function of determining said reference value on the basis of a detection value of said fresh air quantity detection device.

5. The apparatus according to claim 1, wherein said second function is configured to obtain said detection value when an engine speed of said engine set in said fuel-cut sate by said first function becomes a predetermined reference engine speed associated with said reference value.

6. The apparatus according to claim 1, further comprising a seventh function of variably controlling said volume of fresh air taken into said engine intake system, said second function being configured to cause said seventh function to forcibly adjust said volume of fresh air taken into said engine intake system to a predetermined reference volume of fresh air associated with said reference value before obtaining said detection value of said fresh air quantity detection device.

7. The apparatus according to claim 6, wherein said seventh function is configured to control an opening degree of a throttle valve provided in said engine intake system to variably control said volume of fresh air taken into said engine intake system.

8. The apparatus according to claim 6, wherein said seventh function is configured to control an EGR volume by an EGR device operating to return a part of exhaust gas flowing through an exhaust passage of said engine to an intake air passage of said engine to variably control said volume of fresh air taken into said engine intake system.

9. The apparatus according to claim 1, wherein said second function is configured to obtain said detection value for each of a plurality of different reference values in accordance with detecting conditions predetermined for each of said plurality of said different reference values.

10. The apparatus according to claim 1, further comprising an eights function of judging whether or not said engine is set in said fuel-cut state on the basis of an output of an oxygen concentration sensor provided in an exhaust passage of said engine, and a ninth function of permitting said second function to obtain said detection value if said eights function judges that said engine is set in said fuel-cut state.

11. The apparatus according to claim 1, further comprising a tenth function of permitting said third function to execute said error detection calculation when predetermined execution permission conditions are satisfied.

12. The apparatus according to claim 11, wherein said predetermined execution permission conditions include that a time period sufficient to permit said third function to execute said error detection calculation has passed from the time when said third function executed said error detection calculation last time, or a predetermined reference timing.

13. The apparatus according to claim 11, further comprising an eleventh function of varying said time period in accordance with a history of said error detection calculation performed by said third function.

14. The apparatus according to claim 13, wherein said history is the number of times that said third function has executed said error detection calculation.

15. The apparatus according to claim 11, wherein said predetermined execution permission conditions include that said engine is in a warmed-up state.
